(19) United States
(12) Patent Application Publication
(10) Pub. No.: US 2013/0111183 A1
(43) Pub. Date: May 2, 2013

(54) ADDRESS TRANSLATION APPARATUS, ADDRESS TRANSLATION METHOD, AND CALCULATION APPARATUS

(71) Applicant: FUJITSU LIMITED, Kawasaki-shi (JP)

(72) Inventor: Yuji Shirahige, Kawasaski (JP)

(73) Assignee: FUJITSU LIMITED, Kawasaki-shi (JP)

(21) Appl. No.: 13/625,391

(22) Filed: Sep. 24, 2012

(30) Foreign Application Priority Data
Nov. 2, 2011 (JP) 2011-241270

(51) Int. Cl. G06F 12/10

(52) U.S. Cl. 711/206; 711/E12.061

(57) ABSTRACT

An address translation apparatus includes: a first address translation unit to hold, first address information, validity information and correspondence information, the first address information indicating correspondence between a virtual address and a physical address, the validity information indicating a validity of the first address information, and the correspondence information indicating correspondence between first context information corresponding to the first address information and second context information in an access request; an information holding unit to hold context information in the first address information; a comparison unit to compare the first context information with the second context information and update the correspondence information based on a comparison result; and a control unit to search a new first entry having the first address information including the same virtual address as in the access request based on the validity information and the correspondence information and output a physical address in a searched first entry.

### CROSS-REFERENCE TO RELATED APPLICATION(S)

This application is based upon and claims the benefit of priority of the prior Japanese Patent Application No. 2011-241270, filed on Nov. 2, 2011, the entire contents of which are incorporated herein by reference.

### FIELD

The embodiments discussed herein relate to an address translation apparatus, an address translation method, and a calculation apparatus.

### BACKGROUND

A computer uses virtual storage when executing a program that uses a memory space larger than that of physical memory or when performing multi-tasking in which a plurality of processes are executed in parallel. During access to the main memory by a processor, which is a calculation apparatus, in virtual storage mode, a virtual address (VA) output by the processor is translated into a physical address (PA).

The related art is disclosed by Japanese Laid-open Patent Publication No. 2000-163318 or Japanese Laid-open Patent Publication No. 63-81548.

### SUMMARY

According to one aspect of the embodiments, an address translation apparatus comprising: a first address translation unit configured to hold, for each of first entries, first address information, validity information and correspondence information, the first address information indicating correspondence between a virtual address and a physical address, the validity information indicating a validity of the first address information, and the correspondence information indicating correspondence between first context information corresponding to the first address information and second context information included in an access request from a process; an information holding unit configured to hold, for each of the first entries, context information corresponding to an address mode included in the first address information; a comparison unit configured to compare the first context information with the second context information and configured to update the correspondence information based on a comparison result; and a control unit configured to search a new first entry having the first address information including the same virtual address as a virtual address in the access request based on the validity information and the correspondence information, and to output a physical address included in the first address information in a searched first entry.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 depicts an exemplary micro TLB;

FIG. 2 depicts an exemplary processor system;

FIG. 3 depicts an exemplary TLB unit;

FIG. 4 depicts an exemplary micro TLB;

FIG. 5 depicts an exemplary context comparison unit;

FIG. 6 depicts an exemplary CAM unit;

FIG. 7 depicts an exemplary main TLB;

FIG. 8 depicts an exemplary pipeline processing;

FIG. 9 depicts an exemplary TLB search processing; and

FIG. 10 depicts an exemplary TLB search processing.

### DESCRIPTION OF EMBODIMENTS

During translation from a virtual address to a physical address, a reference is made to an address translation table, which is stored in the main memory, or a translation lookaside buffer (TLB), which caches part of information of the address translation table for translation from a virtual address to a physical address.

A two-level hierarchy structure including both a micro TLB, which has a small capacity (a small number of entries) and provides high-speed accessibility, and a main TLB, which has a large capacity (a large number of entries) and provides low-speed accessibility, may be adopted. If no information corresponding to a virtual address is found in the micro TLB, the main TLB is referenced. If no information corresponding to the virtual address is found in the main TLB, the address translation table of the main memory is referenced.

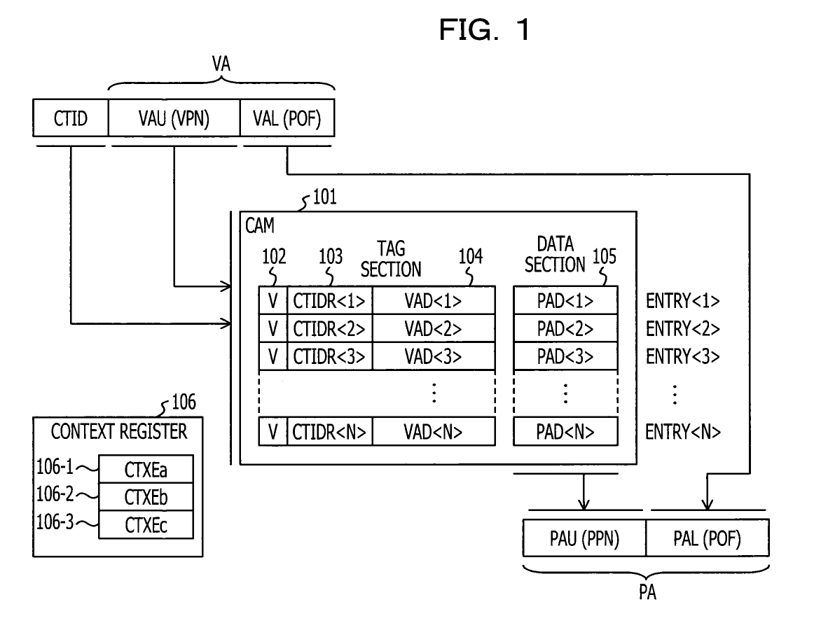

FIG. 1 depicts an exemplary micro TLB. The micro TLB depicted in FIG. 1 stores, as a context ID, two bits of information that indicate the address mode of address information held by each entry, in an architecture having three address modes. Accordingly, address translation may be performed for a plurality of address modes.

A CAM (content addressable memory) unit 101 in FIG. 1 includes a tag section and a data section. The tag section holds a validity flag (V) 102, which indicates whether the entry is valid, a context ID (CTIDR<i>) 103, and a virtual address (VAD<i>) 104 as an entry (Entry<i>). The data section holds the physical address (PAD<i>) 105 corresponding to the virtual address (VAD<i>) 104 as Entry<i>. The character i is a natural number subscript (i=1, 2, 3, . . . , N). A context register 106 holds a context indicating the internal state of the CPU (Central Processing Unit), such as the values of registers included in the CPU. The context register 106 includes a first register 106-1, a second register 106-2, and a third register 106-3.

For example, the context ID of a first address mode may be “00” and the context (CTXEa) of the first address mode may be held in the first register 106-1 of the context register 106. For example, the context ID of a second address mode may be “01” and the context (CTXEb) of the second address mode may be held in the second register 106-2 of the context register 106. For example, the context ID of a third address mode may be “10” and the context (CTXEc) of the third address mode may be held in the third register 106-3 of the context register 106. The contexts may be information (process identification information) used by an OS etc. to identify a process.

When a processor accesses the main memory, the micro TLB is searched using a virtual address and context ID included in an access request from the processor. For example, the upper part VAU (VPN) of a virtual address VA and the context ID (CTID) are used as a search tag to search all entries (Entry<1> to Entry<N>) in the CAM unit 101 in parallel at the same time. The upper part VAU (VPN) of the virtual address VA may correspond to a virtual page number and the lower part VAL (POF) of the virtual address VA may correspond to an intra-page offset.

If there is an entry in which the validity flag (V) 102 indicates validity, and the context ID (CTID) coincides with the context ID (CTIDR), and the upper part VAU (VPN) of the virtual address VA coincides with the virtual address VAD, then a TLB entry hit is set. The physical address PAD of the entry that has hit is combined as the upper part PAU (PPN) with the lower part PAL (POF) and is output as the translated address, for example, a physical address PA. If no entry in the micro TLB hits, the virtual address and context of the access request is supplied to the main TLB and the TLB is searched.

The upper part PAU (PPN) of the physical address PA corresponds to a physical page number and the lower part PAL (POF) of the physical address PA corresponds to an intra-page offset. The value of the lower part PAL (POF) may be substantially the same as the value of the lower part VAL (POF) of the virtual address VA corresponding to the intra-page offset.

When the ID of a running process coincides with the process ID when the information is saved, the virtual address to be translated into a physical address may be compared with the saved virtual address. When the number of processes exceeds the maximum value that can be handled by the process ID unit of the TLB, the address information of the TLB may be disabled selectively.

A difference virtual address space is assigned for each process. For example, the correspondence between a virtual address and a physical address differs for each process. When switching between processes is performed in the same address mode, context switching occurs. When the information in the context register is rewritten, the address mode information (entry) registered in the micro TLB before the information is rewritten is disabled (flashed) by the validity flag (V) 102.

When switching between contexts is performed again, because the information of the switched context is not registered in the micro TLB, no entry in the micro TLB hits and address translation may take much time. When, for example, switching between the privileged mode and the user mode frequently occurs in the operating system (OS), the performance may degrade.

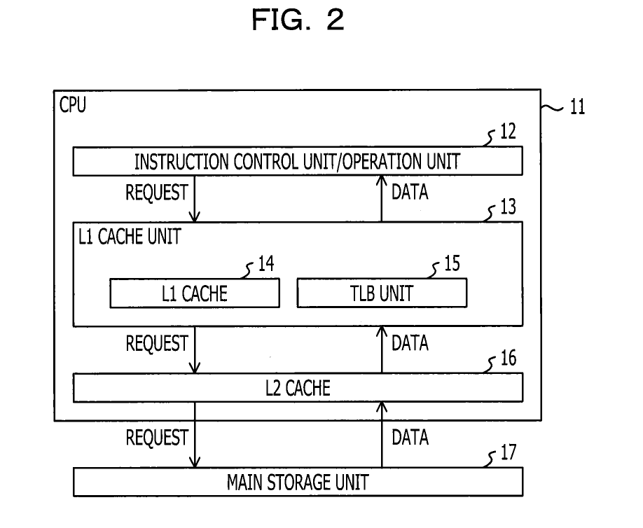

FIG. 2 depicts an exemplary processor system. A central processing unit (CPU) 11 depicted in FIG. 2 as a calculation apparatus includes an instruction control unit/operation unit 12, a primary cache unit 13 including a primary cache (L1 cache) 14 and a translation lookaside buffer (TLB) unit 15, and a secondary cache (L2 cache) 16. The CPU 11 including the instruction control unit/operation unit 12, the primary cache unit 13, and the secondary cache 16 may be included in, for example, one chip and is coupled to a main storage unit 17 such as the main memory via a bus etc. (not depicted).

The instruction control unit/operation unit 12 controls instruction processing performed by the CPU 11 or performs calculation of data according to an instruction. The instruction control unit/operation unit 12 reads an instruction or data from a storage device, interprets the read instruction, and performs calculation etc. The primary cache 14, the secondary cache 16, and the main storage unit 17 may store instructions or data read by the instruction control unit/operation unit 12 or calculation results output from the instruction control unit/operation unit 12.

The primary cache 14 stores part of information (such as instructions or data) stored in the secondary cache 16. The primary cache 14 responses to an instruction, data, etc. faster than the secondary cache 16 according to a request from the instruction control unit/operation unit 12. The secondary cache 16 stores part of instructions or data stored in the main storage unit 17. The main storage unit 17 stores an address translation table (including information indicating the correspondence between virtual addresses and physical addresses), which is used during translation from a virtual address into a physical address. The TLB unit 15 caches part of information of the address translation table for translation from a virtual address into a physical address and translates a virtual address output from the instruction control unit/operation unit 12 into a physical address.

When a request for reading data or the like is issued from the instruction control unit/operation unit 12, the TLB unit 15 translates a virtual address into a physical address and the physical address is used to access storage devices (the primary cache 14, the secondary cache 16, and the main storage unit 17). If the requested data is present in the primary cache 14, the data is provided for the instruction control unit/operation unit 12 from the primary cache 14. If the requested data is not present in the primary cache 14, the secondary cache 16 is searched. If the requested data is present in the secondary cache 16, the data is provided for the instruction control unit/operation unit 12 from the secondary cache 16 via the primary cache 14. If the requested data is not also present in the secondary cache 16, the data is provided for the instruction control unit/operation unit 12 from the main storage unit 17 via the secondary cache 16 and the primary cache 14.

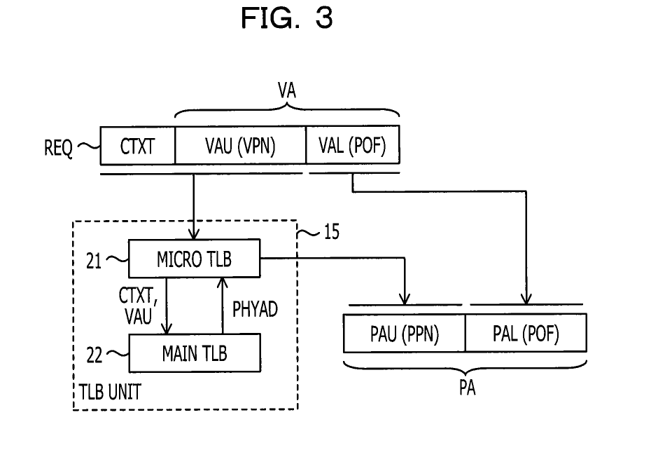

FIG. 3 depicts an exemplary TLB unit. The TLB unit 15 has a two-level hierarchy structure as in the data cache. The TLB unit 15 has a micro TLB 21, which has a small capacity (a small number of entries) and provides high-speed accessibility, and a main TLB 22, which has a large capacity (a large number of entries) and provides low-speed accessibility. The micro TLB 21 adopts, for example, a fully associative reference method. The main TLB 22 adopts, for example, a set associative reference method.

When the instruction control unit/operation unit 12 issues a request REQ, the TLB unit 15 searches for information using a virtual address VA specified by the request REQ, and translates the virtual address VA into a physical address PA. TLB unit 15 makes a search using the upper part VAU (VPN) of the virtual address VA specified by the request REQ and a context CTXT. The upper part VAU (VPN) of the virtual address VA may correspond to a virtual page number and the lower part VAL (POF) of the virtual address VA may correspond to an intra-page offset. For example, the virtual address VA may take up 64 bits (<0:63>), the upper part VAU (VPN) may take up bits 13 to 63 <13:63>, and the lower part VAL (POF) may take up bits 0 to 12 <0:12>. The context CTXT (for example, 13 bits) is information (process identification information) for identifying a process controlled by an OS etc.

When the upper part VAU (VPN) of the virtual address VA and the context CTXT are used to search the micro TLB 21 for the corresponding physical address information (the upper part PAU (PPN) of the physical address PA), the physical address information that has been searched for is output. The output information is combined as the upper part PAU (PPN) with the lower part PAL (POF) to obtain the translated physical address PA. The upper part PAU (PPN) of the physical address PA may correspond to a physical page number and the lower part PAL (POF) of the physical address PA may correspond to an intra-page offset. The value of the lower part PAL (POF) corresponding to the intra-page offset may be substantially the same (address value) as the value of the lower part VAL (POF) corresponding to the intra-page offset of the virtual address VA. For example, the physical address PA may take up 48 bits (<0:47>), the upper part PAU (PPN) may take up bits 13 to 47 <13:47>, and the lower part PAL (POF) may take up bits 0 to 12 <0:12>.

If the corresponding physical address information is not present in the micro TLB 21 as a result of a search in the micro TLB 21, the upper part VAU (VPN) of the virtual address VA and the context CTXT are provided for the main TLB 22 and the main TLB 22 is searched. If the corresponding physical address information (the upper part PAU (PPN) of the physical address PA) is present in the main TLB 22, information PHYAD is output from the main TLB 22 to the micro TLB 21 and registered in the micro TLB 21. The micro TLB 21 is searched again and the corresponding physical address information (the upper part PAU (PPN) of the physical address PA) is output. The entry in the micro TLB 21 in which the information from the main TLB 22 is registered may be determined as appropriate using the validity flag or the LRU algorithm etc.

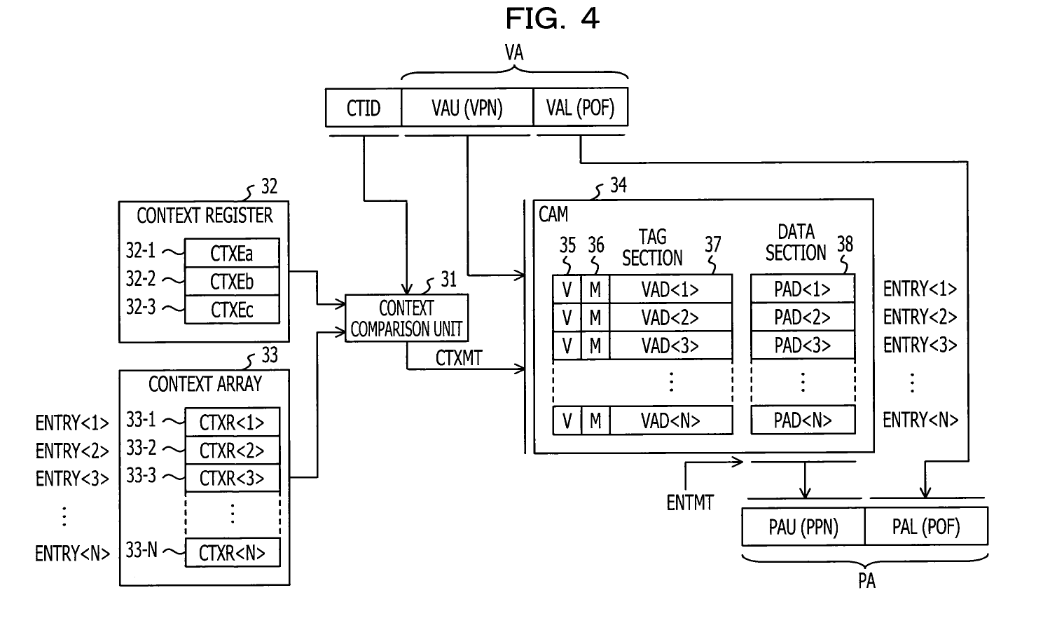

FIG. 4 depicts an exemplary micro TLB. FIG. 4 depicts the micro TLB 21 with an architecture having three address modes: a first address mode, a second address mode, and a third address mode. The micro TLB 21 includes a context comparison unit 31, a context register 32, and a context array 33, and a content addressable memory (CAM) unit 34.

The context register 32 includes a first register 32-1, a second register 32-2, and a third register 32-3. The first register 32-1 holds a context (CTXEa) of the first address mode. The second register 32-2 holds a context (CTXEb) of the second address mode. The third register 32-3 holds a context (CTXEc) in the third address mode.

The context array 33 may include the same number of registers 33-i as the number of entries held in the CAM unit 34. The character i is a natural number subscript (i=1, 2, 3, . . . , N). For example, the register 33-i of the context array 33 corresponds to each entry (Entry<i>) held in the CAM unit 34. The register 33-i holds the context (CTXR<i>) of the corresponding Entry<i> in the CAM unit 34.

The context comparison unit 31 receives the context ID (CTID), a context held in the context register 32, and a context held in the context array 33. The context ID (CTID) may be two bits of information indicating an address mode.

The context comparison unit 31 compares a context held in the context register 32 with a context held in the context array 33 on an entry-by-entry basis, for all entries in the context array 33. For example, the contexts (CTXEa, CTXEb, and CTXEc) held in the first to third registers 32-1 to 32-3 are compared with the context (CTXR<i>) held in the register 33-i.

When the context of the current address mode coincides with the context (CTXR<i>) held in the register 33-i, the context comparison unit 31 activates and outputs a context match signal CTXMT corresponding to the entry. For example, when the context of an entry held in the CAM unit 34 coincides with the context (the context of the process that has issued an access request) of the current address mode, the context comparison unit 31 activates and outputs the context match signal CTXMT.

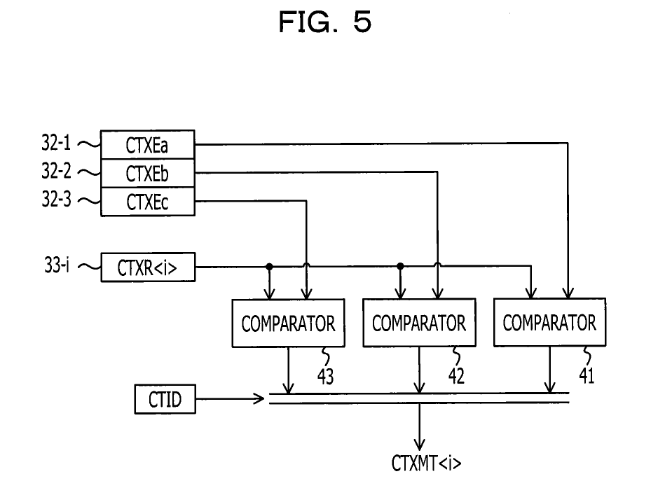

FIG. 5 depicts an exemplary context comparison unit. The structure for one entry is depicted in FIG. 5, but the context comparison unit may include the structure in FIG. 5 for each of the entries held in the CAM unit 34.

A comparator 41 in FIG. 5 compares the context (CTXEa) held in the first register 32-1 of the context register 32 and the context (CTXR<i>) held in the register 33-i of the context array 33. A comparator 42 compares the context (CTXEb) held in the second register 32-2 of the context register 32 and the context (CTXR<i>) held in the register 33-i of the context array 33. A comparator 43 compares the context (CTXEc) held in the third register 32-3 of the context register 32 and the context (CTXR<i>) held in the register 33-i of the context array 33. The comparators 41, 42, and 43 activate an output when the contexts of interest coincide with each other.

One of outputs from the comparators 41, 42, and 43 as a result of the comparison is selected according to the context ID (CTID) and is output as the context match signal CTXMT<i>. In the first address mode, an output from the comparator 41 is selected and output as the context match signal CTXMT<i>. In the second address mode, an output from the comparator 42 is selected and output as the context match signal CTXMT<i>. In the third address mode, an output from the comparator 43 is selected and output as the context match signal CTXMT<i>.

The CAM unit 34 in FIG. 4 includes a tag section and a data section. The tag section holds a validity flag (V) 35, a match flag (M) 36, and a virtual address (VAD<i>) 37 as Entry<i>. The data section holds the physical address (PAD<i>) 38 corresponding to the virtual address (VAD<i>) 37 as Entry<i>. The validity flag (V) 35 indicates whether an entry is valid or invalid. For example, the validity flag (V) 35 is set to 1 if an entry is valid; the validity flag (V) 35 is set to 0 if an entry is invalid. Even if the context register is rewritten, the validity flag (V) 35 of the entry corresponding to the context before being rewritten is maintained without being disabled. The match flag (M) 36 indicates whether an entry is information of the context of the current address mode. When the corresponding context match signal CTXMT<i> is active, the match flag (M) 36 is set to ON (1).

The CAM unit 34 may search all entries (Entry<1> to Entry<N>) at the same time through parallel operation by using, as a search tag, the upper part VAU (VPN) of a virtual address VA specified by a request REQ. If the validity flag (V) 35 indicates validity, the match flag (M) 36 is ON, and the upper part VAU (VPN) of the virtual address VA coincides with the virtual address VAD, then the entry match signal ENTMT of the corresponding entry is activated and output. The entry match signal ENTMT is activated when the TLB entry hits or is inactivated when the TLB entry misses.

When one entry match signal ENTMT is active because, for example, the TLB entry hits, the physical address PAD of the entry that hits is output from the CAM unit 34. The output physical address PAD is combined as the upper part PAU (PPN) with the lower part PAL (POF) to obtain the translated physical address PA. If no entry in the micro TLB hits, the virtual address and context specified by the request REQ are provided for the main TLB.

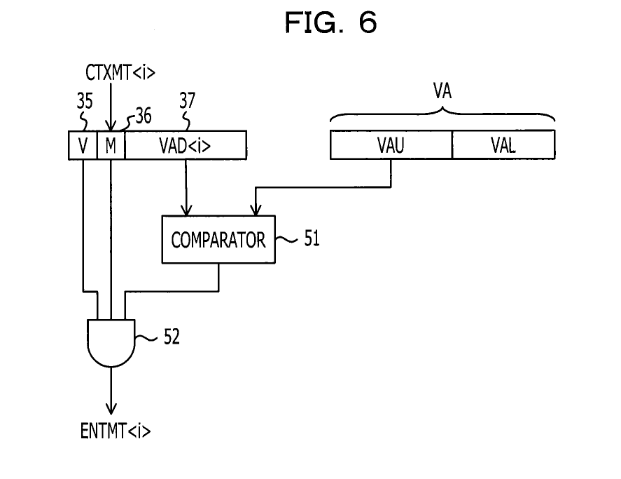

FIG. 6 depicts an exemplary CAM unit. The structure for determining whether a TLB entry hits or misses for one entry is depicted in FIG. 6, but the CAM unit 34 may include the structure in FIG. 6 for each entry.

The comparator 51 depicted in FIG. 6 compares the upper part VAU of the virtual address VA specified by the request REQ with the virtual address (VAD<i>) 37 of an entry and, if they coincide with each other, makes the output active (true). An AND circuit 52, which is a three-input logical AND calculation circuit, receives the validity flag (V) 35, the match flag (M) 36, and an output from the comparator 51 and outputs the calculation results as the entry match signal ENTMT<i>.

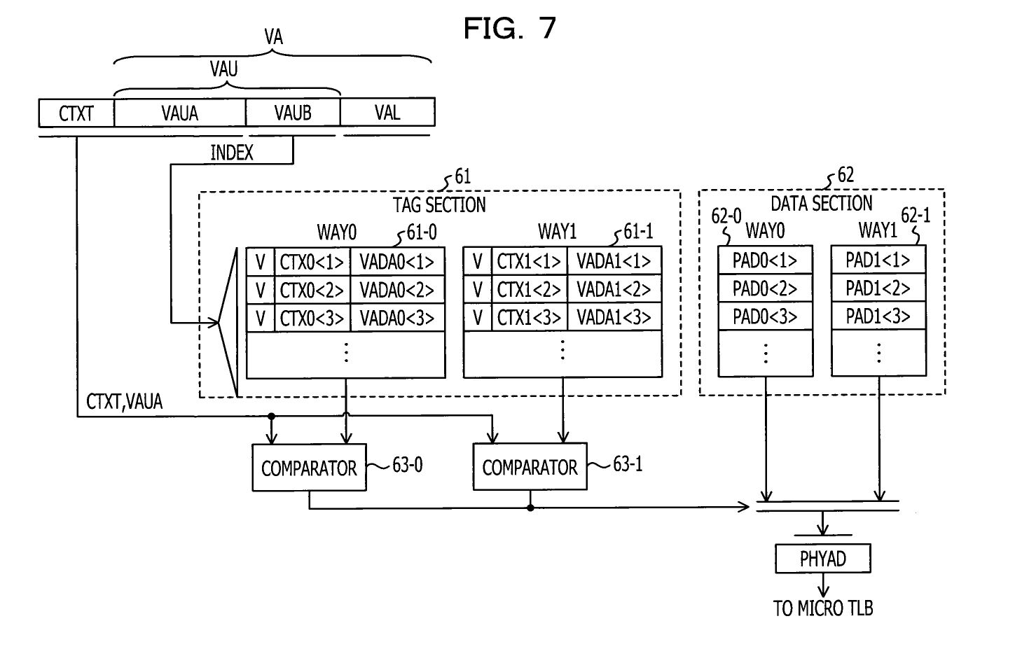

FIG. 7 depicts an exemplary main TLB. The main TLB 22 in FIG. 7 adopts the 2-way set associative method. A tag section 61 in FIG. 7 includes a tag section 61-0 of way0 and a tag section 61-1 of way1. A data section 62 includes a data section 62-0 of way0 and a data section 62-1 of way1.

The tag section 61-0 of way0 holds, as an entry, a validity flag (V), which indicates whether the entry is valid or invalid, a context (CTX0<j>), and a virtual address (VADA0<j>). The tag section 61-1 of way1 holds, as an entry, a validity flag (V), which indicates whether the entry is valid or invalid, a context (CTX1<j>), and a virtual address (VADA1<j>). The data section 62-0 of way0 holds a physical address (PAD0<j>) corresponding to the virtual address (VADA0<j>) as an entry. The data section 62-1 of way1 holds a physical address (PAD1<j>) corresponding to the virtual address (VADA1<j>) as an entry. The character j is a natural number subscript (j=1, 2, 3, . . . ).

In the main TLB 22, the tag sections 61-0 and 61-1 and the data sections 62-0 and 62-1 are referenced using, as an index tag INDEX, a second upper part VAUB corresponding to part of the upper part VAU of a virtual address VA specified by the request REQ. Entries identified by the index tag INDEX are output from the tag sections 61-0 and 61-1 to comparators 63-0 and 63-1, respectively.

The comparator 63-0 compares the context CTXT and the first upper part VAUA corresponding to part of the upper part VAU of the virtual address VA with the context (CTX0<j>) and virtual address (VADA0<j>) of an entry output from the tag section 61-0. When the context CTXT coincides with the context (CTX0<j>), the first upper part VAUA of the virtual address VA coincides with the virtual address (VADA0<j>), and the validity flag (V) indicates validity, then an entry hit is assumed. Accordingly, the entry is identified by the index tag INDEX and the physical address (PAD0<j>) output from the data section 62-0 is output to the micro TLB as the corresponding physical address PHYAD.

The comparator 63-1 compares the context CTXT and the first upper part VAUA of the virtual address VA with the context (CTX1<j>) and virtual address (VADA1<j>) of an entry output from the tag section 61-1. When the context CTXT coincides with the context (CTX1<j>), the first upper part VAUA of the virtual address VA coincides with the virtual address (VADA1<j>), and the validity flag (V) indicates validity, then an entry hit is assumed. Accordingly, the entry is identified by the index tag INDEX and the physical address (PAD1<j>) output from the data section 62-1 is output to the micro TLB as the corresponding physical address PHYAD.

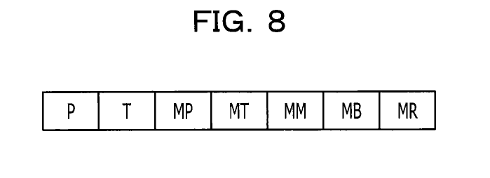

FIG. 8 depicts an exemplary pipeline processing. The pipeline processing in FIG. 8 may be pipeline processing for a TLB search. In FIG. 8, no entry hit is found in the micro TLB and data obtained based on an entry hit in the main TLB is written to the micro TLB. The processing in the P stage and T stage may be the pipeline processing in the micro TLB. The processing in the MP stage, MT stage, MM stage, MB stage, and MR stage may be the pipeline processing in the main TLB.

In the P stage (context array access stage), the micro TLB accesses the context array 33. The context comparison unit 31 compares the context held in the context register 32 with the context held in the context array 33. For example, a decision is made as to whether the context of Entry<i> held in the CAM unit 34 of the micro TLB 21 coincides with the context (the context of the current address mode) of the process that has issued an access request. In the T stage (micro TLB access stage), the CAM unit 34 is accessed in the micro TLB. A search is made as to whether the entry containing information of the physical address PA corresponding to the virtual address VA specified by the request REQ is present in the CAM unit 34.

When the entry containing information of the physical address PA corresponding to the specified virtual address VA is not present in the micro TLB 21 (CAM unit 34) (for example, when a hit is not found), a request is issued to the main TLB and the processing proceeds to the pipeline processing in the main TLB. In the MP stage (priority stage), a request is selected from a plurality of requests. In the MT stage (main TLB access stage), part of the virtual address VA is used as an index tag to access the memory (the tag section 61 and the data section 62) of the main TLB 22. In the MM stage (main TLB match stage), the comparators 63-0 and 63-1 corresponding to a match circuit determines whether an item corresponding to the virtual address VA etc. specified by the request REQ is present in results read from the memory (the tag section 61) of the main TLB 22. In the MB stage (entry select stage), when an item corresponding to the specified virtual address VA etc. is present, the corresponding data read from the memory (the data section 62) is selected. In the MR stage (micro TLB write stage), the data selected in the MB stage is written to (registered in) the micro TLB 21. In registration in the micro TLB 21 in the MR stage, the entry to which data is written is determined using the validity flag or the LRU algorithm etc.

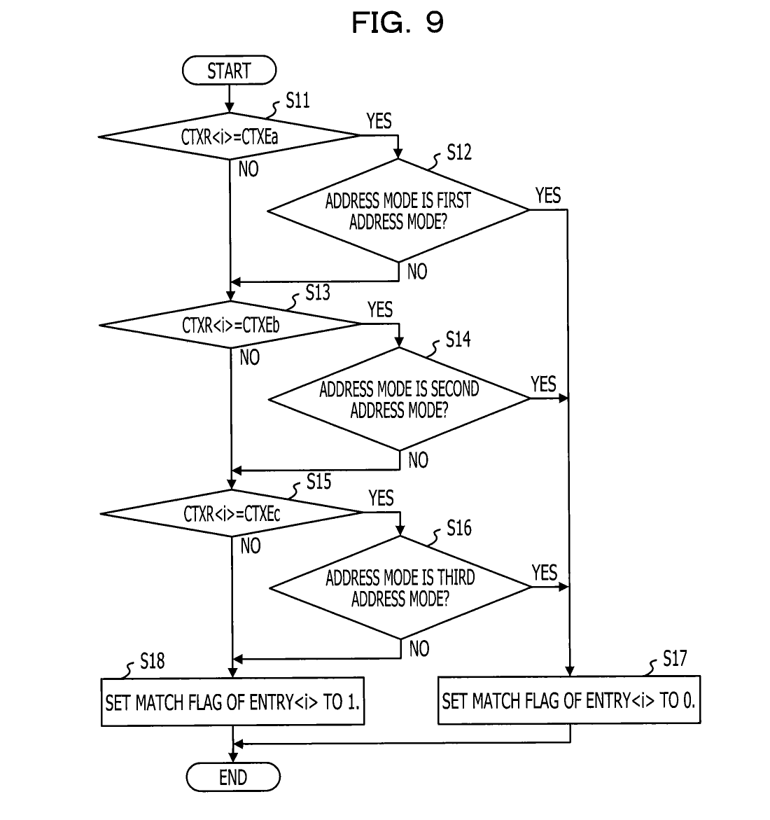

FIG. 9 depicts an exemplary TLB search processing. The processing in FIG. 9 may be context array search processing in the micro TLB 21. In a cycle in the P stage depicted in FIG. 8, the processing in FIG. 9 is performed in parallel for the individual entries. In the context array search processing, the context held in the register 33-i of the context array 33 is compared with the contexts held in the first to third registers 32-1 to 32-3 of the context register 32.

When context array search processing starts, the context comparison unit 31 compares the context (CTXR<i>) held in the register 33-i with the context (CTXEa) held in the first register 32-1, in operation S11. When they coincide with each other, the processing proceeds to operation S12. When they do not coincide with each other, the processing proceeds to operation S13.

In operation S12, the context comparison unit 31 determines whether the address mode is the first address mode based on the input context ID (CTID). When the address mode is the first address mode, the processing proceeds to operation S17. When the address mode is not the first address mode, the processing proceeds to operation S13.

In operation S13, the context comparison unit 31 compares the context (CTXR<i>) held in the register 33-i with the context (CTXEb) held in the second register 32-2. When they coincide with each other, the processing proceeds to operation S14. When they do not coincide with each other, the processing proceeds to operation S15. In operation S14, the context comparison unit 31 determines whether the address mode is the second address mode. When the address mode is the second address mode, the processing proceeds to operation S17. When the address mode is not the second address mode, the processing proceeds to operation S15.

In operation S15, the context comparison unit 31 compares the context (CTXR<i>) held in the register 33-i with the context (CTXEc) held in the third register 32-3. When they coincide with each other, the processing proceeds to operation S16. When they do not coincide with each other, the processing proceeds to operation S18. In operation S16, the context comparison unit 31 determines whether the address mode is the third address mode. When the address mode is the third address mode, the processing proceeds to operation S17. When the address mode is not the third address mode, the processing proceeds to operation S18.

In operation S17, the context comparison unit 31 activates and outputs the context match signal CTXMT<i>. Accordingly, the match flag (M) 36 of Entry<i> is set to 1 and the processing ends. The match flag (M) 36 of Entry<i> is set to 0 in operation S18 and the processing ends.

The comparison between the context held in the register 33-i and the contexts held in the first to third registers 32-1 to 32-3 may be made in sequence or in parallel for the first to third address modes.

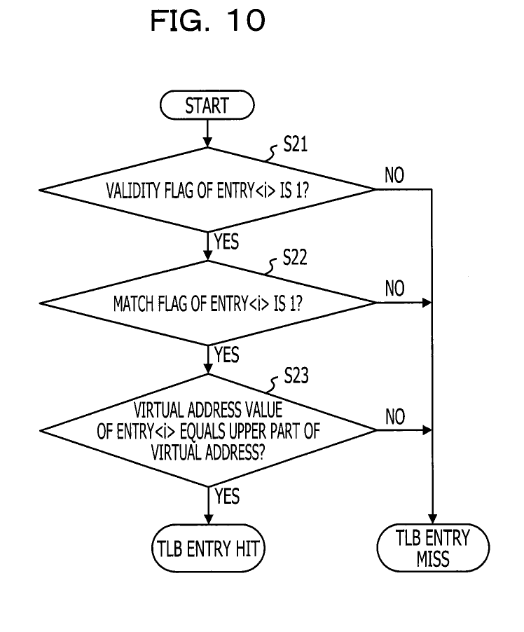

FIG. 10 depicts an exemplary TLB search processing. The processing in FIG. 10 may be TLB search processing in the micro TLB 21. In a cycle in the T stage depicted in FIG. 8, the processing in FIG. 10 is performed in parallel for the individual entries.

When TLB search processing starts, the CAM unit 34 determines whether the validity flag (V) 35 of Entry<i> is 1 in operation S21. When the validity flag (V) 35 is 1, the processing proceeds to operation S22. When the validity flag (V) 35 is not 1, a TLB entry miss for Entry<i> is assumed and the processing ends.

In operation S22, the CAM unit 34 determines whether the match flag (M) 36 of Entry<i> is 1. When the match flag (M) 36 is 1, the processing proceeds to operation S23. When the match flag (M) 36 is not 1, a TLB entry miss for Entry<i> is assumed and the processing ends.

In operation S23, the CAM unit 34 compares the virtual address value (VAD<i>) 37 of Entry<i> with the upper part VAU of the virtual address VA specified by the request REQ. When they coincide with each other, a TLB entry hit for Entry<i> is assumed and the processing ends. When they do not coincide with each other, a TLB entry miss for Entry<i> is assumed and the processing ends. The decisions may be made in the order of the validity flag (V) 35, the match flag (M) 36, and the virtual address value (VAD<i>) 37 or the decisions may be made in parallel.

When switching between processes is performed in a predetermined address mode, context switching occurs. Even when the information in the context array 33 is rewritten, the information registered in the micro TLB 21 is held without being disabled (without validity flag (V) 35 being disabled). The context of the information registered in the micro TLB 21 is held for each entry in the context array 33. The match flag (M) 36 is provided for each entry in the micro TLB 21. The validity of the information registered in the micro TLB 21 is determined with the match flag (M) 36.

In the micro TLB 21, the context comparison unit 31 compares the context (the context of the current address mode) of a process that made an access request in P stage cycle with the context held in the context array 33 based on an access request issued from the instruction control unit/operation unit 12. When they coincide with each other, the match flag (M) 36 of the entry is set to ON (1). When they do not coincide with each other, the match flag (M) 36 of the entry is set to OFF (0).

In a cycle in T stage, which follows the P stage, when the CAM unit 34 of the micro TLB 21 is accessed, the micro TLB 21 is searched with reference to the match flag (M) 36. The entries for which the match flag (M) 36 is ON (for example, the entries held in the CAM unit 34) are searched for the entry corresponding to the context of the process that made an access request. When switching between processes is performed, context switching occurs. If the information in the context array 33 is rewritten, the match flags (M) 36 of the entries that do not correspond to the modified context are set to OFF and the entries that do not correspond to the modified context are excluded from a virtual address search in the micro TLB 21. Accordingly, even if the information in the context array 33 is rewritten, the validity flag (V) 35 of the entry does not have to be set to OFF, for example, the information in the entry does not have to be disabled, thereby reducing the occurrence of an entry miss during switching to the original process again. As a result, time needed for address translation and degradation in performance may be reduced.

For example, it is assumed that, in the first address mode, information when the context is (A) is held in the CAM unit 34 as Entry<1>. It is also assumed that an access request is issued in the first address mode when the context is (A). At this time, since these contexts coincide with each other as a result of comparison in the P stage, the match flag (M) 36 of Entry<1> is set to ON to enable the entry. In addition, if the virtual address specified in a request coincides with the virtual address (VAD<1>) of Entry<1> in reference in the T stage, then a TLB entry hit is assumed, address translation is performed, and the corresponding physical address is obtained.

If the context is switched to (B) in the first address mode in this state, since these contexts do not coincide with each other as a result of comparison in the P stage, the match flag (M) 36 of Entry<1> is set to OFF. In reference in the subsequent T stage, since the match flag (M) 36 is OFF, a TLB miss is assumed in Entry<1>.

If the context is switched to (A) again in the first address mode and an access request is issued in the context that is (A), the contexts coincide with each other in comparison in the P stage and the match flag (M) 36 of Entry<1> is set to ON. In reference in the T stage, Entry<1> is referenced as a valid entry.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An address translation apparatus comprising:
a first address translation unit configured to hold, for each of first entries, first address information, validity information and correspondence information, the first address information indicating correspondence between a virtual address and a physical address, the validity information indicating a validity of the first address information, and the correspondence information indicating correspondence between first context information corresponding to the first address information and second context information included in an access request from a process;
an information holding unit configured to hold, for each of the first entries, context information corresponding to an address mode included in the first address information;
a comparison unit configured to compare the first context information with the second context information and configured to update the correspondence information based on a comparison result; and
a control unit configured to search a new first entry having the first address information including the same virtual address as a virtual address in the access request based on the validity information and the correspondence information, and to output a physical address included in the first address information in a searched first entry.

2. The address translation apparatus according to claim 1, wherein the comparison unit changes the correspondence information to information indicating a coincidence when the comparison result indicates the coincidence.

3. The address translation apparatus according to claim 2, wherein the validity information in the searched first entry indicates validity and the correspondence information in the searched first entry indicates the coincidence.

4. The address translation apparatus according to claim 1, further comprising,
a second address translation unit to hold, for each of a second entry, second address information indicating correspondence between a virtual address and a physical address.

5. The address translation apparatus according to claim 4, wherein, when being unable to search the new first entry, the control unit searches a new second entry having the second address information including the same virtual address as the virtual address in the access request, and outputs a physical address included in the searched second address information.

6. The address translation apparatus according to claim 1, wherein
the instruction control unit includes a pipeline having a plurality of stages,
the comparison unit compares the first context information with the second context information in a first stage included in the plurality of stages, and
the control unit searches the new first entry in a second stage that is included in the plurality of stages and follows the first stage.

7. The address translation apparatus according to claim 1, wherein the comparison unit compares the first context information included in the first entries with the second context information item contemporaneously.

8. The address translation apparatus according to claim 1, wherein the control unit searches the plurality of first entries contemporaneously.

9. The address translation apparatus according to claim 1, wherein, during switching from a first process to a second process, the control unit validates the validity information in a first entry holding the second context information corresponding to the second process.

10. An address translation method comprising:
holding, for each of first entries, first address information, validity information and correspondence information, the first address information indicating correspondence between a virtual address and a physical address, the validity information indicating a validity of the first address information, and the correspondence information indicating correspondence between first context information corresponding to the first address information and second context information included in an access request from a process;
holding, for each of the first entries, a context information corresponding to an address mode included in the first address information;
comparing the first context information with the second context information;
updating the correspondence information based on a comparison result;
searching a new first entry having the first address information including the same virtual address as a virtual address in the access request based on the validity information and the correspondence information; and
outputting a physical address included in the first address information in the searched first entry.

11. The address translation method according to claim 10, further comprising,
changing the correspondence information to information indicating a coincidence when a comparison result indicates the coincidence.

12. The address translation method according to claim 10, further comprising,
searching the new first entry from among the plurality of first entries in which the validity information indicates validity and the correspondence information indicates coincidence.

13. A calculation apparatus comprising:
an instruction control unit that executes a process and outputs an access request including a virtual address;
a first address translation unit that holds, for each of first entries, first address information, validity information and correspondence information, the first address information indicating correspondence between a virtual address and a physical address, the validity information indicating a validity of the first address information, and the correspondence information indicating correspondence between first context information corresponding to the first address information and second context information included in an access request from a process;
an information holding unit that holds, for each of the first entries, a context information corresponding to an address mode included in the first address information;
a comparison unit that compares the first context information with the second context information and updates the correspondence information based on a comparison result; and
a control unit that searches a new first entry having the first address information including the same virtual address as a virtual address in the access request based on the validity information and the correspondence information, and outputs a physical address included in the first address information in a searched first entry.
